(19) United States
(12) Patent Application Publication
(10) Pub. No.: US 2011/0185660 A1
(43) Pub. Date: Aug. 4, 2011

(54) TRANSLUCENT BUILDING ELEMENT AND EQUIPMENT AND METHOD FOR MANUFACTURING THE SAME

(76) Inventor: Andreas Roye, Aachen (DE)

(21) Appl. No.: 12/675,058

(22) PCT Filed: Mar. 14, 2008
(86) PCT No.: PCT/EP2008/053128

§ 371 Date: Feb. 24, 2010

(30) Foreign Application Priority Data
Aug. 24, 2007 (DE) 10 2007 040 083.9

(51) Int. Cl. E04C 1/42; B05D 3/10

(52) U.S. Cl. 52/307; 427/161

(57) ABSTRACT

Translucent building element and method and equipment for manufacturing the same, where the translucent building element made of a castable matrix, especially concrete, is casted and incorporates a fiber composite with translucent fibers. The translucent fibers are placed in the translucent fiber composite in that way, that they form with at least one surface of the building element, which is designed for the light entrance or light exit, at least two different angles. For manufacturing, first a fiber composite is supplied to a first transporting device, which feeds the fiber composite into a coating device, in which the fiber composite is coated with the castable matrix. Using a second transporting device the coated fiber composite is conveyed out of the coating device to a formwork, in which the coated fiber composite is placed layer wise, and the castable matrix with the enclosed translucent fibers is cured to a translucent slab. After retracting, the surfaces of the slab are treated in that way, that the cross sectional surfaces of the translucent fibers are laid open.

The presented invention is related to a translucent building element made of a castable matrix, particularly concrete, with molded translucent fibers and an equipment an method for manufacturing the translucent building element.

Translucent respectively light conducting building elements, particularly made of concrete, are already known. However, the known building elements show only one direction, in which the light can travel through the building element. For example from WO 03/097054 A1 a building stone is known, which contains embedded light conducting fibers in a castable matrix, whereas the light conducting fibers are arranged in that way, that the light is conducted from one surface to the opposing surface of the block shaped stone. The light conducting fibers are here basically arranged parallel, as well as in vertical as in horizontal direction.

More DE 20 2007 000 753 U1 shows a translucent building element with molded light conducting fibers, which are embedded for example using the yard ware of a canvas, a knit fabric or a felt. Hence it follows, that the light conduction is only possible in the direction of the inserted weft (optical fiber).

In DE 9310500 U1 translucent building elements are described, which shall be used at the setting up of walls, slabs or floors. Only with optical fibers, which are placed in the through-thickness direction of the building elements, the above described function can be fulfilled.

Although the translucent building elements made of concrete give designers of buildings or interior architects a large creative freedom, the manufacturing method of such building elements is still very time-consuming and has to be carried out for the most parts manually.

Thus, the light conducting fibers of WO 03/097954 A1 are laid one by one on a layer of concrete, upon which another layer of concrete is poured and on which another layer of fibers is laid. This method is continued until the desired height of the slab is reached. With this method primarily elongated concrete elements are manufactured, which are then cut perpendicular to their longitudinal direction, in which also the optical fibers span, in pieces of a desired length. Thus brick sized or panel shaped building elements are generated, which are translucent in one direction.

According to DE 20 2007 000 753 U1 an endless textile canvas, which is winded on a bobbin, is placed layer wise like a meander in a formwork, whereas on each placed layer of the canvas a layer of matrix is poured, before this layer of castable matrix is again covered with another layer of canvas. Here also this method is repeated until the desired height of the slab is reached. After curing of the castable matrix the block is cut into pieces, which are then used as panel shaped building elements. Also in these building elements the direction of the light conduction runs only in one direction, namely the through-thickness direction of the panel-shaped, plane building elements.

Since, as shown above, neither a device nor a method for the automatic serial production of translucent building elements, particularly made of concrete, are known, the by the prior art manufactured building elements are very expensive, because of their at least partial manual production. Moreover the manual pouring of the castable matrix leads to an inhomogeneous distribution of the optical fibers in the translucent building element, which results in an unaesthetic appearance, particularly when the translucent building element is illuminated. This effect is intensified by pouring concrete directly into the formwork, this results in a dislocation or even buoying upwards of the previously embedded optical fibers.

An object of the present invention is, to present a translucent building element, where the light can not only be conducted in one direction, but also in directions which are different from the through-thickness of the building element.

Another object of the present invention is to present an apparatus for manufacturing of such building elements and a method, how such building elements can be produced in mass production in a mainly automatic production process. At this the method shall ensure a homogenous distribution of the optical fibers in the castable matrix.

The objects are achieved by a method with the properties according to claim 1, with an apparatus according to claim 8 and a building element according to claim 14. More favorable specifications result from the respective dependent claims.

According to the invention a translucent building element made of a castable matrix, particularly concrete, possesses an embedded translucent fiber composite, where the translucent fiber composite contains translucent respectively optical fibers, which conduct light, that falls on a first surface of the building element thought the building element in that way, that the light exits on the surface opponent to said first surface and also exits at least on one other surface of the building element. This means, that the translucent fibers are arranged in the building element in that way, that they form with at least one surface the building element, which is designed for the light entrance or light exit, at least two different angles.

With many applications block shaped building elements are used as basic elements, which means, according to the invented building element, that the light falling on one first surface of the building element can exit simultaneously on the surface opponent to said first surface and on the neighboring side-surface. Moreover the light can, if the fibers are placed that way, exit also on the bottom and top surfaces of the building element. For a cylindrical building element, e.g. a column, the light can enter on one side of the column, e.g. on half of the lateral area of the column, and exit on the other side of the column as well as on the top and the bottom surfaces. The invented building element is not restricted on regular shaped elements, such as blocks or cylinders as any other spatial forms with any section can be made. To ease the description of the invention a block shaped building element will be referred to, but the mentioned properties apply respectively for any other possible design of the invented building element.

In the translucent fiber composite according to the invention a fiber composite respectively a fiber network is molded into a castable matrix, e.g. concrete or fine concrete, where the fiber composite contains translucent fibers. These translucent fibers are monofilaments, under which also rods fall upon, or multifilament made of translucent (transparent) materials. Furthermore the term translucent fibers/rods cover also optical fibers or fiber optics. For light conduction, which is for translucent building elements mainly the conduction of visible light, particularly for shorter distances, it is not necessary, to use technically high grade fiber optics, which are elsewhere used in transferring data. For translucent building elements it is sufficient to use translucent fibers for which no high grade requirements on the quality of the conducted light are made. Of course also high grade optical fibers can also be used to conduct light in the invented building element, if, e.g. the dimensions in longitudinal direction of a column, are very high and/or for surfaces an increased light efficiency in comparison to the light conduction efficiency in another direction is desired or e.g. if a pattern shall be generated by differences in brightness for each different colour.

For the invented translucent building element a fiber composite is used, which is e.g. manufactured by weaving, knitting, knotting, braiding, twisting or any other manufacturing method to bond fibers to a composite. The term “fiber composite” shall here be used as generic term for any fiber arrangement.

The fiber composite used in the translucent building element according to the invention, can be a two-dimensional, i.e. a mainly plane fiber composite, or a three dimensional fiber composite. As implied above it is not necessary for the light conduction/transmissibility in a building element, that all fibers of the fiber composite, which is embedded in a castable matrix, are translucent fibers. It is sufficient for the light transmissibility, if textile fabrics, meant for reinforcement, consist at least partially of translucent fibers. Furthermore it is imaginable, that such reinforcements, meant for the reinforcement of a building element, are additionally provided with translucent fibers, to add to the reinforcement of the building element the feature of translucency.

As arises from the things mentioned above, all known kinds of fiber composites can be used for the building element according to the invention, whereas the translucent fibers are either an element of the textile or either added to such a textile. As arises from the things mentioned above, all known kinds of fiber composites can be used for the building element according to the invention, whereas the translucent fibers are either an element of the fiber composite or either added to a fiber composite. Here it is important in the context of the invention, to arrange the translucent fibers, which are arranged upon or in the fiber composite in different directions, so light, which e.g. shines on only on surface of the building element, is diverted in different directions. Thus it is possible, that light, shining on the building element, e.g. sunlight, exits at multiple surfaces, which do not have to be parallel to the light entrance surface. It is also possible that light enters at multiple surfaces and exits at only one ore more surfaces.

For the building elements known by the prior art the light enters at one surface of the building element and exits at one opponent, mainly parallel, surface of this building element. This can be explained by the light conducting fibers, which are, according to the prior art, arranged in the translucent building elements only in the direction of the light entrance, i.e. one-dimensional. Differing from this the translucent fibers of the translucent building element according to the present invention, are arranged in multiple different directions, i.e. more-dimensional, in the translucent building element.

As described above, all two-dimensional and three-dimensional fiber composites can be used. For three dimensional fiber composites, e.g. made by spacer knit fabrication, light can be conducted in all spatial directions. Additionally to the light conduction also load depending designed reinforcing elements, e.g. steel, alkali resistant textiles etc., can be inserted, to increase the resistance/stability of the building elements.

By this more-dimensional arrangement of the translucent fibers also other effects can be reached, e.g. the bundling of light, which shines on different surfaces or a curved surface of the building element an exits at only one surface of the building element. Or light of different wavelength, which enters at different surfaces, can exit at only one surface.

As shown at the beginning, translucent building elements are so far manufactured mainly manually, i.e. with a low degree of automation, which results in relatively high production costs. The translucent building element according to the present invention, is manufactured in a device, which first coats the used fiber composite with the castable matrix, an then delivers the coated fiber composite into a formwork, in which the castable matrix is cured. When a mainly plane fiber composite is used, the delivery of the fiber composite, coated with the castable matrix, is carried out layer by layer. To generate the layers of castable matrix and fiber composite in the formwork, the fiber composite can be cut or chopped according to the measurements of the formwork but also fed endless, e.g. wound on a bobbin, to the device for coating the fiber composite. When feeding the fiber composite endlessly, the delivery of the fiber composite, coated with the castable matrix, is preferably done in meanders, which means, one layer is placed on the subjacent layer in that way, that the coated fiber composite is placed layer-wise by an oscillating movement.

In the device, according to the present invention, to manufacture the translucent building element, according to the present invention, a fiber composite is at first supplied to a first transporting device, which feeds the fiber composite to a coating device, which applies the castable matrix on the fiber composite. In this coating device the fiber composite is covered by the castable matrix on both sides. A following transporting device, conveys the coated fiber composite out of the coating device into a formwork, where the coated fiber composite is placed layer-wise. After filling the formwork to the desired height, i.e. until the desired dimension of the slab is reached, the castable matrix is cured in the formwork. The cured blocks of castable matrix contain a number of layers of the fiber composite with translucent fibers/rods. The final translucent building elements, according to the present invention, are manufactured in such a way, that the slabs are cut in panels of different thicknesses. The direction of the primary motion is predefined by the direction of these translucent fibers, on which the main attention is turned to. Shall, for example, the direction of the light conduction by mainly in the direction of the weft fibers, the direction of the primary motion on the slab is perpendicular to the weft fibers.

Depending on the size and shape also other directions for cuts are possible. After cutting the casted block in building elements of the desired size the outer surfaces of have to be treated, to remove possible remains from the surfaces off the translucent fibers at the light entrance and light, exit surfaces. Not only but for example the light entrance and light exit surfaces of the translucent fibers of the building elements cut out of the casted block can be cleared of remaining matrix by milling or polishing. Favorably the cleared surfaces of the translucent fibers are protected by a transparent film, e.g. epoxy resin, from environmental forces.

If the fiber composite is fed endlessly to the device, according to the presented invention, the fiber composite coated with the castable matrix is also conveyed continuously out of the coating device, so that the placement of the coated fiber composite in the formwork is done in meanders. To place the fiber composite, coated with the castable matrix, in meanders into the formwork, a relative movement between the transporting device and the formwork takes place, so that the fiber composite, coated with the castable matrix, comes to lie in the formwork meandering. This can on one hand be achieved by an oscillating linear movement of the transporting device while the formwork stands still, and on the other hand by an oscillating linear movement of the formwork, while the transporting device stands still relative to the formwork. Imaginable is also a linear movement of the entire device for coating the fiber composite together with the transporting devices, relative to the formwork.

If ready made, e.g. tailored cut fiber composites are coated with the castable matrix in the coating device, an oscillating linear movement between the coating device and the formwork is not necessary, but also the single fiber composites can for example be placed on a conveyor belt and from there also manually placed in the formwork. This can again take place automatically by appropriate controlled movements between conveyor belt and formwork, so that the fiber composites, coated with the castable matrix, come to lie in the formwork layer-wise.

Single fiber composite mats, coated with castable matrix or not coated, can also be placed manually or automatically one above the other in the formwork.

Thereby not coated fiber composites can be clamped into a frame and the frames can be placed one above the other and bonded together, whereas the previous fiber composite is casted with the matrix before placing the next frame on the previous frame or the base panel. By bonding the frames together in vertical direction a kind of framework is formed, in which the casted block can cure. As in the previous mentioned method with placing an endless fiber composite in a formwork, the casted block is also treated after curing or at least after reaching a form stability, by cutting, milling, polishing and/or coating.

For manufacturing the building element with a device according to the presented invention, as mentioned above, a method was presented, how such translucent building elements can automatically and mechanically be produced and manual work can largely be avoided. With the method, according to the presented invention, the fiber composite with the translucent fibers is all around, for planar fiber composites basically from the upper and lower side, coated with the castable matrix. Next the coated fiber composite is conveyed out of the coating device by a second transporting device an fed to a formwork, where the coated fiber composite is placed layer-wise respectively in meanders for curing. The feeding of the coated fiber composite takes place in such way, that surplus castable matrix will not flow into the formwork. Because some castable matrix, which is not sticking to the fiber composite, can, after coating, drop off the fiber composite and into the formwork, this can lead to anomalies between the single layers of the coated fiber composite. It is therefore important, to collect the castable matrix that drops off in such a way, that it will not flow into the formwork. This can for example be achieved by a suitable stripping device (wiper) at the transporting device that conveys the coated fiber composite out of the coating device with the castable matrix.

In the method, according to the presented invention, the textile composite is coated in a coating device. This can for example be reached by immersion of the fiber composite info a basin with castable matrix or by any other known coating principle. Here primarily laminating, spraying, impregnating, dipping etc. are to named. All these principles are known to the expert when mentioning the word coating and shall here not be discussed further more. Important for the presented method is, that the fiber composite is coated evenly with the castable matrix. Castable matrix dropping off the coated fiber composite should hereby, and also by continued transport not flow into the formwork, but should be collected and led back to the coating device, Thus a homogenous layer-wise or meander like structure of the casted block is possible.

By manufacturing translucent concrete elements, according to the invention presented, with the respective method, the homogeneity, i.e. the distribution between translucent fibers and castable matrix, will become more even, which shows in the end product in an even distribution of the fibers, which results in an even light emission. By using the method presented and especially by the preventing the matrix, not sticking to the fiber composite, to flow into the formwork, irregularities, which especially are seen in the concrete elements made after state of the art methods, can be largely avoided.

Favorably, in the presented method, the coating of the fiber composite can take place while feeding the fiber composite through a basin. When coating the fiber composite it is not important, when the necessary castable matrix is generated, but rather, especially when processing an endless fiber composite, that it is continuously coated with the castable matrix in the desired layer thickness. The matrix can thereby be generated just in time according to the process

Regarding the generation of the castable matrix it shall be mentioned, that the viscosity of the matrix, the parameters of the fiber composite (diameter, distance and kind of the translucent fibers/rods, textile process etc.) and the process parameters while coating (transportation speed, filling height etc,) the distance between the single layer of the translucent fibers/rods in the translucent concrete elements can be specifically influenced. It has to be considered, that, the more liquid (low viscous) the castable matrix is made, the more the layers blur in the formwork, which can also be intended depending to the design.

Depending on the used coating method, the viscosity of the castable matrix will be different, whereas the viscosity can be adjusted by adding short fibers. The viscosity should be adjusted in such way, that the placement of the coated fiber composite in the formwork takes place with a defined layer distance between the translucent fibers/rods. The placement takes place favorably meander-like by an alternating movement of the coating device, e.g. on guide rails above the formwork or by an alternating movement of the formwork, also e.g. on guide rails. The use of a changing device is possibly, which should not influence the adhesion of the castable matrix on the fiber composite in a negative way.

By the method, according to the presented invention, an alternated placing and casting of the placed fiber composite in the formwork with matrix can be avoided and the textile/the fiber composite can be transported continuously together with the castable matrix and at the some time as the matrix be fed to and placed in the formwork.

As for the step of placing the fiber composite in the formwork it shall be mentioned, that the curing of the castable matrix normally takes place, after the layer is placed in the formwork. If applicable also a previous curing and stiffening of the matrix can take place or can be artificially induced, e.g. to further avoid the blurring of the layers after placing them in the formwork.

If the coating is conducted with a coating matrix of a very high viscosity and a high green strength, and especially after a vacuum or thermal treatment of the coated fiber composite, the placement of the coated fiber composite can also take place on a table or a conveyor belt without the use of a formwork. This means that the curing of the matrix has not necessarily to take place in a formwork.

After curing of the castable matrix in which the fiber composite is closely embedded, the surfaces like the light entrance surface or the light exit surface can be brought to the desired size to optimize the light transmission by cutting, milling polishing or else. Favorably the formwork or the curing of the castable matrix is chosen in such a size, that multiple translucent building elements can be made. Of course also a single production of building elements, according to the presented invention, can be made. For every single building element a separate formwork is needed, if a high viscous matrix can no be used.

If the building element, according to the presented invention, is produced using a endless fiber composite, whereas the coated fiber composite is placed meander-like in the formwork, the areas where the change of direction of the fiber composite takes place, have to be cut off the casted block. This is necessary because of the change of direction of generally 180° no light can exit out of the diverted fibers. The cutting of the ends of the cured slab perpendicular to the plane of the layers is necessary, to lay open the end surface of the translucent fibers in the translucent building element. This cutting is also necessary on all other sides of the casted block, if the end surface of all translucent fibers of the fiber composite shall be laid open.

For the here described cutting, which can also be achieved by milling or polishing, the working direction will be chosen generally perpendicular to the direction of the optical fibers, to achieve the best possible light exit surface, respectively light entrance surface. Although the working direction can also be angular to the direction of the fiber, whereas the visible surface of the translucent fiber is enlarged. The critical angel for the emission of light should here be considered.

The single steps of the above presented method can partially take place at the same time and/or more process steps can be added. The here presented method is preferably conducted continuously. It is also possible, that the coated fiber composite is chopped after coating with castable matrix, and that the single layers are laid on a conveyor belt or on another transportation device, and then placed discontinuously layer-wise in the formwork.

The building element, according to the presented invention, the respective device for the manufacturing of the translucent building element and the method therefore are explained in the following figures. The figures show favorable layouts of the invention, upon which the invention however is not limited. Schematically depicted are in:

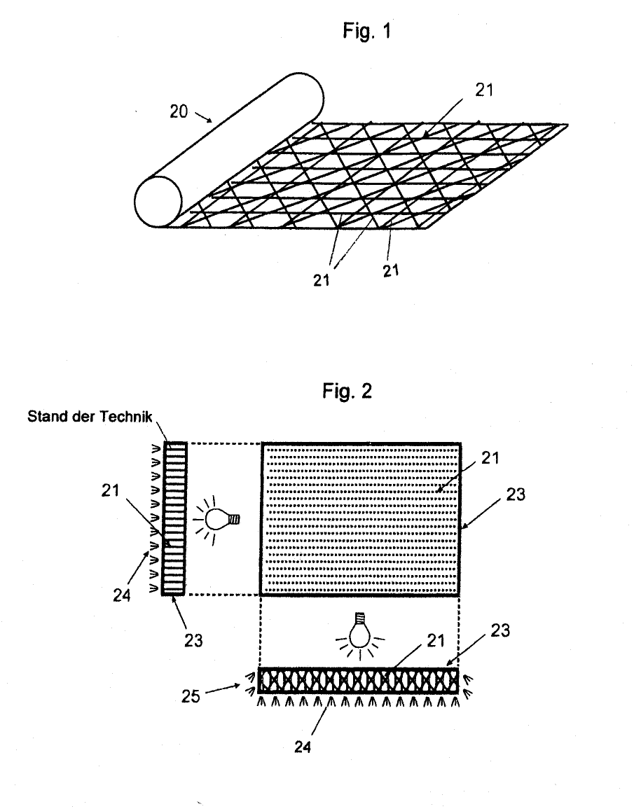

FIG. 1: schematically a plane section of a rolled and endless textile composite with light transmitting fibers lengthwise, crosswise and in a diagonal orientation

FIG. 2: schematically a light transmitting building element, in which a fiber composite accord. FIG. 1 is embedded

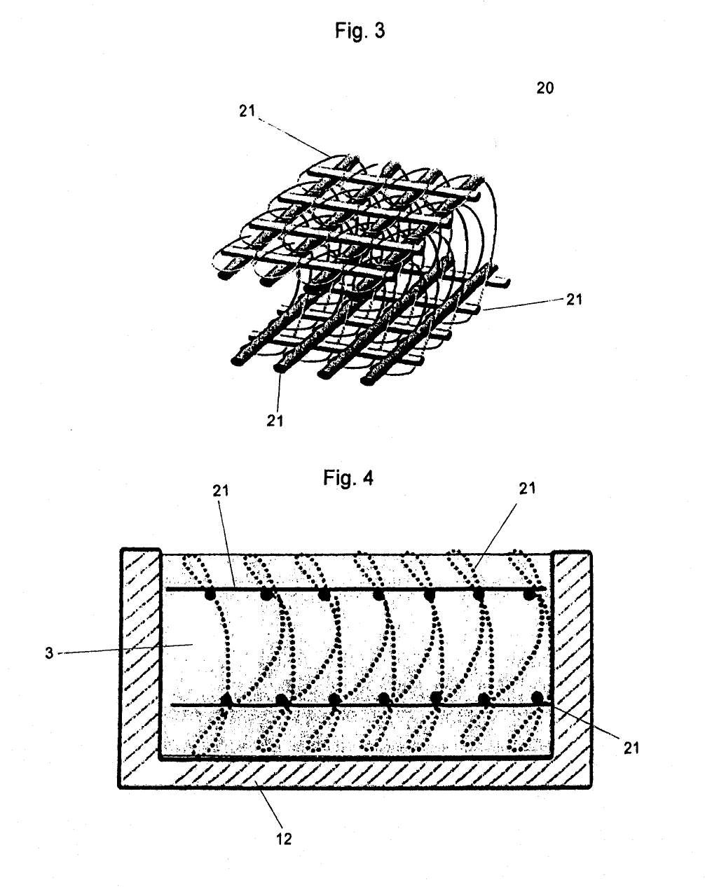

FIG. 3: schematically a section of a 3D-fiber composite with light transmitting fibers

FIG. 4: schematically a light transmitting building element, in which a 3D-fiber composite accord. to FIG. 3 is embedded.

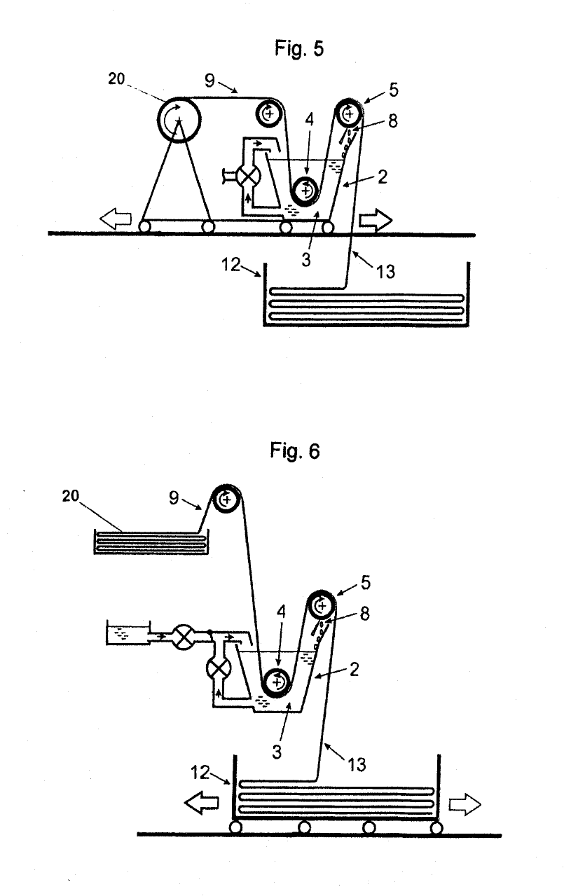

FIG. 5: schematically a device according to the present invention for the production of the light transmitting concrete element according to the present invention.

FIG. 6: schematically an additional alternative of the device according to FIG. 5

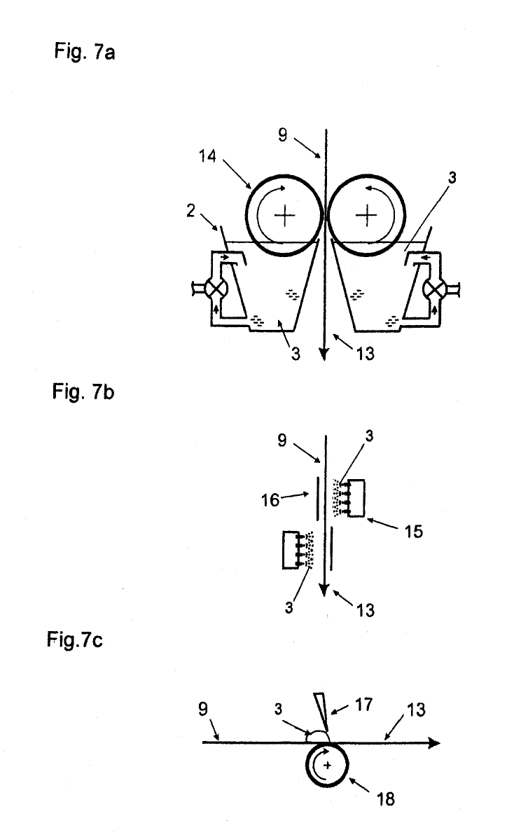

FIG. 7a-c: further possibilities of coating the fiber composite within the device according to the present invention for the production of the light transmitting concrete elements.

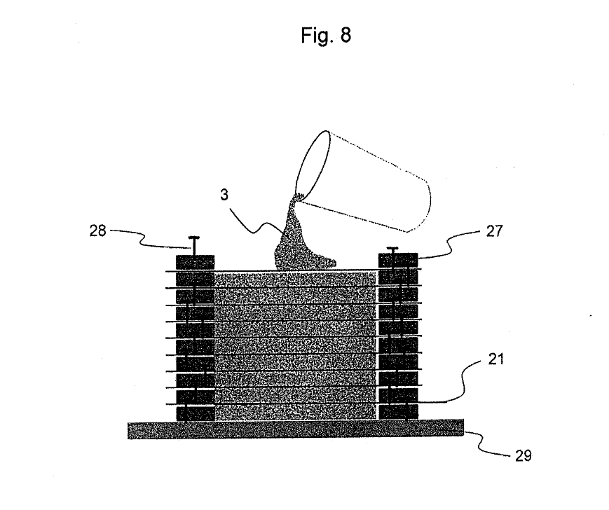

FIG. 8: schematically the layout of a molded block with the fixed fiber composites within the framework.

FIG. 1 shows a coil of a fiber composite 20 with lengthwise 9, crosswise an diagonally orientated light transmitting fibers 21. In case of embedding such a fiber composite with lengthwise, crosswise and diagonally orientated optical fibers in a matrix system, the light transmission (light exit), compare FIG. 2, can be realized also via the lateral faces, which are not directly opposite to the light entrance. FIG. 2 left scheme shows a light transmission according the existing state of technology.

As shown with FIG. 3 and FIG. 4, the 3D-fiber composites with light transmitting fibers can be used, where a light transmission in all directions can be realized. In FIG. 3, exemplarily and schematically such a 3D-fiber composite is demonstrated, as it is embedded in the matrix according to the present invention.

As can be seen in the figure, the light transmitting fibers can be oriented length and crosswise as well as through-the-thickness of the 3D-fabric. A combination with a fiber composite according to FIG. 1 is possible as well. In FIG. 4 a embedded 3D-fiber composite is shown within a mould 12. The used fiber composite 20 can be made by using a double needle bar raschel process for example, but, the light transmitting fibers forming a mesh have to be erected to end outside the reinforcement layer. This erection is necessary, to ensure, that the following milling process opens the ends of the optical fibers without destroying the reinforcement layers.

The reinforcement lengthwise (0° direction), the reinforcement crosswise (90° direction) in the fabric and the meshes of the fabric can be formed with optical fibers. Different fiber diameters can be used, as shown exemplarily in FIG. 3.

A device for the production of the light transmitting element is shown in FIG. 5 and FIG. 6. A linear uncoated fiber composite 20 on a coil 1 is let via a conveying equipment 9 to a basin 2 containing the liquid matrix 3. A deflecting roller 4 which is inside the basin 2 with the liquid matrix 3 delivers the fiber composite through the matrix 2 by what the fiber composite 2 is coated.

Another conveying equipment 5 delivers the coated fiber composite 13 upward moving out of the basin 2 and feeding the same to the mould 12. The coated fiber composite 13 is layed into the mould 12 by an alternating linear movement of the entire device. The coating device shows a stripping device 8 close to the conveying device 5 to return excessive matrix to the basin 2.

FIG. 6 shows another alternative for the production of the translucent building element. Similar devices are indicated with the same reference numbers. Different to the example in FIG. 5, the uncoated fiber composite 21 is taken from an arrangement in layers 1 and fed to the entire device.

The conveying device 4 delivers the fiber composite through the liquid matrix 2 and leads the coated fiber composite 13 to the conveying device 5 and finally to the mould 12, returning excessive matrix back to the basin 2. Different to the example in FIG. 5, here the mould is moving in lateral movements relatively to the coating device.

The positioning of the fiber composite in the mould 12 is realized layer by layer and the matrix 3 can cure within the mould.

As shown in FIG. 5 and FIG. 6, the deflection areas of the fiber composite in the mould 13 have to be cut off to ensure a light transmission through the block.

For light transmitting fibers crosswise and in diagonal orientation it is advantageous to mill and polish also the lateral faces of the block. So a good light conduction can be realized. If applicable, all surfaces of the light transmitting element should be protected with a translucent layer.

In FIG. 5 and FIG. 6 an endless fiber composite material is let through a basin with matrix and coated with matrix on both sides. The same process can also be adapted to fiber composites with defined shorter dimensions, working similar to the paper feeding in a copy machine.

FIG. 7a -7c show further possibilities of realizing the coating of the fiber composite 20 with matrix. In FIG. 7a a special coating process (german: pflatschen) is shown, where two counter rotating rollers 14 at least touching the matrix basin 3 and taking matrix to its surface. Between the two rollers 14, the fiber composite 10 is conveyed and simultaneously coated by the rollers 14 with matrix 3.

In FIG. 7b it is shown, how the fiber composite 20 is coated with matrix 3 by a spreading process from each side individually. It is advantageous to place the spreading jets of the two sides in different positions in the process, and putting a deflector always opposite to the jet devices.

The conveying of the coated fiber composite can be ensured by a conveying device as shown in FIG. 5 and FIG. 6.

In FIG. 7 c) the fiber composite 20 is conveyed with the roller 18 through the basin 2 (compare FIG. 6 and FIG. 7) and coated from one side with a fixed stripping device (wiper) 17. The one-sided-coated fiber composite finally can be layed into the mould 12 in meanders, providing the multi-layer system of optical fibers.

Especially FIG. 6 shows, that the endless fiber composite 20 could also be cutted into pieces, and then in a stapled way being provided to the conveying device. The providing of the cutted fiber composite slides can be piece-by-piece, by pairs or even group-wise.

The production of light transmitting concrete elements based on single slides of fiber composites with defined dimensions can be advantageous especially for the automated machine production of customized one-piece-flow goods of light transmitting concrete. An example of indivualized production is given in FIG. 4. Such a production requires a number of moulds, provided for example on a conveyer belt below the coating device and then filled individually with the different layers of fiber composites.

### Reference numerals

2 basin
3 castable matrix
4 Deflection roller
5 Conveying roller
8 Stripping device
9 Uncoated fiber composite
10 Coating device
12 Mould
13 Coated fiber composite
14 Coating roller
15 Jet spray device
16 Deflection
17 Stripping device (wiper)
18 Conveying roller
20 Coiled fiber composite
21 Light transmitting fiber
23 Light transmitting element
24 Light emission on the surface of the light transmitting element
25 Light emissino on the lateral faces of the light transmitting element
27 Framework
28 Mounting device
29 Ground plate

1.-18. (canceled)

19. Method for manufacturing a translucent building element, characterized in that a fiber composite (9), that contains translucent fibers (21), is at first supplied to a first transporting device, which feeds the fiber composite continuously to a coating device, where the fiber composite is continuously coated with a castable matrix, and from which, utilizing a second transporting device, the coated fiber composite is continuously conveyed out of the coating device into a formwork, where the coated fiber composite is placed layer wise, and the castable matrix with the enclosed translucent fibres is cured to a translucent slab, on which, after retracting, the surfaces are treated in that way, that the cross sectional surfaces of the translucent fibers are laid open.

20. Method according to claim 19, where said fiber composite (9) is pulled through a basin (2) containing a castable matrix (3).

21. Method according to claim 20, where said coated fiber composite is continuously meander shaped placed in the formwork.

22. Method according to claim 20, where said retracted slab is cut into pieces and the light entrance and light exit surfaces are laid open by milling or polishing.

23. Method according to claim 20, where said retracted slab is cut into pieces, which form said translucent building elements (23), where the outer surfaces of these translucent building elements are coated with a transparent film.

24. Apparatus for manufacturing a translucent building element (23), comprising:
a device for supplying .a fiber composite (9), which contains translucent fibers (21)
a first transporting device for continuously feeding the fiber composite (9) to a coating device (10)
a coating device (10) for continuously coating the fiber composite (9) with a castable matrix
a second transporting device for continuously conveying the coated fiber composite (13) from the coating device (10) to a formwork (12) and
a device for generating a relative movement between the second transporting device and the formwork (12) to place the coated fiber composite (13) layer by layer for curing the castable matrix (3).

25. Apparatus according to claim 24, in which said coating device (10) is movable in longitudinal direction or in lateral direction of said formwork (12) and said formwork (12) is not movable while placing said coated fiber composite (13) into said formwork or said coating device (10) is not movable and said formwork (12) is movable in longitudinal direction or in lateral direction while placing said coated fiber composite (13) into said formwork.

26. Translucent building element (23) made out of a castable matrix (3), especially concrete, with a molded fiber composite, which contains translucent fibers (21), that are placed in the fiber composite in the building element (23) in that way, that they form with at least one surface the building element (23), which is designed for the light entrance or light exit, at least two different angles.

27. Building element according to claim 26, with a fiber composite comprising translucent fibers, which are arranged placed in two or more directions to the longitudinal direction of the fiber composite, such that light can be conducted from one surface of the building element in two or more spatial directions.

28. Building element according to claim 27, where the fiber composite shows a three-dimensional arrangement and is casted in three-dimensional arrangement into the building element (23).

29. Building element according to claim 26, where the translucent fibers (21) are optical fibers made of glass or polymers.

30. Building element according to claim 27, where the translucent fibers (21) are optical fibers made of glass or polymers.

31. Building element according to claim 29, where the translucent fibers (21) in the building element (23) are placed layer above layer.

32. Building element according to claim 29, where the light entrance and light exit surfaces are milled or polished.

33. Building element according to claim 30, where the light entrance and light exit surfaces are milled or polished.

34. Building element according to claim 32, where the light entrance and light exit surfaces are coated with a transparent film,

35. Building element according to claim 33, where the light entrance and light exit surfaces are coated with a transparent film.
